(19) United States
(12) Patent Application Publication
(10) Pub. No.: US 2003/0180468 A1
(43) Pub. Date: Sep. 25, 2003

(54) Silicone release coating compositions

(76) Inventors: Stephen Edward Cray, Vale of Glamorgan (GB); John Francis, Neath (GB)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/333,312

(22) PCT Filed: Jul. 4, 2001
(86) PCT No.: PCT/GB01/02988

(30) Foreign Application Priority Data
Jul. 18, 2000 (GB) 00174680

(51) Int. Cl. B05D 3/02

(52) U.S. Cl. 427/387

(57) ABSTRACT

A release coating composition comprising a siloxane (A) having terminal alkenyl groups, a crosslinking agent (B) having organohydrogensiloxane groups and a catalyst for the hydrosilylation reaction between (A) and (B), that contains an aminoalkyl siloxane or aminoalkyl silane to improve anchorage of the release coating to the substrate.

This invention relates to silicone based release coating compositions and to release coating of polymer substrates.

Silicone based release coatings are useful in applications where relatively non-adhesive surfaces are required. Single sided liners, for example, backing sheets for pressure sensitive adhesive labels, are usually adapted to temporarily retain the labels without affecting the adhesive properties of the labels. Double sided liners, for example interleaving papers for double sided and transfer tapes, are used to ensure the protection and desired unwind characteristics of a double sided self-adhesive tape or adhesive film. The release coating is required to adhere well to the liner while having relatively low adhesion to the adhesive so that the label can be removed from the liner by a predetermined peel force.

A substrate is coated by applying a silicone based release coating composition onto the substrate and subsequently curing the composition. Solventless coating compositions are preferred to avoid release of volatile organic materials. The preferred curing mechanism is thermally initiated hydrosilylation, which can readily be modified to vary the adhesive force between the release coating and the adhesive label.

The liner substrate to which the release coating is applied is usually paper, but there is an increasing requirement for release coating of polymer substrates such as polyester film, polypropylene or polyethylene. Release coatings cured by hydrosilylation have not shown consistent anchorage to polymer substrates; the adhesive force between the film and the release coating has been found to decrease with time.

The basic constituents of silicone based release coating compositions that are cured by hydrosilylation are:

1) an alkenylated siloxane, typically a polydiorganosiloxane with terminal alkenyl groups,

2) a polyorganohydrogensiloxane cross-linking agent, designed to cross-link the alkenylated polydiorganosiloxane and

3) a catalyst, to catalyse the aforementioned cross-linking reaction.

Silicone based release coating compositions consisting of the three essential constituents and optionally an inhibitor designed to prevent the commencement of curing below a prerequisite cure temperature are generally referred to as premium release coating compositions.

In order to control the level of release force (the adhesive force between the release coating and the adhesive label) from a release coating it is common practice for a silicone based release coating composition to contain a release modifier. Release coating compositions having the required release force can be formulated from a premium release coating composition by adjusting the level of modifier.

The problem of anchorage of siloxane release coatings to polymer films has previously been overcome by the use of high viscosity alkenyl polysiloxanes in conjunction with a crosslinker used at a high Si—H to vinyl molar ratio, as described in EP-A-356054. This incurs further problems. The high viscosity polymer is difficult to handle. The coating has a high release force with most adhesives, and the release force varies with time, reducing on storage.

EP-A-272809 describes an adhesion promoter for radiation curable organopolysiloxanes comprising a silane or polysiloxane having in its molecule at least one organic group possessing aliphatic unsaturation and at least one amino group.

EP-A-920986 describes a reclaimable release coating composition which includes a blend of an adhesion promoter and a silicone release agent which may be applied from aqueous solution, dispersion or emulsion. The adhesion promoter is a phthalic acid ester, an acrylate polymer containing either N-methylolacrylamide or methacrylamide and esterified triazine, or a condensed polymer of an aminoalkylalkoxysilane.

U.S. Pat. No. 6,020,412 describes a controlled release coating comprising a vinyl-containing polysiloxane, a methylhydrogenpolysiloxane, an epoxyalkyl silane and a platinum-containing catalyst. The composition of Example 20 additionally contains a polymer of N-(2-aminoethyl)-3-aminopropyl trimethoxy silane.

U.S. Pat. No. 4,366,286 describes an organic solvent-based non-stick coating consisting of a polyorganosiloxane with hydroxyl end groups, a crosslinking agent of the formula RSiX3 where X is a hydrolysable group and R is an alkyl, alkenyl, aryl or aminoalkyl group, an organic tin compound as catalyst and a siloxane organic graft copolymer.

According to the invention a release coating composition for application to a substrate, particularly a polymer substrate, comprising a siloxane (A) having terminal alkenyl groups, a crosslinking agent (B) having organohydrogensiloxane groups and a catalyst for the hydrosilylation reaction between (A) and (B), is characterised in that the release coating composition contains an aminoalkyl siloxane or aminoalkyl silane to improve anchorage of the release coating to the substrate.

The siloxane (A) is an organopolysiloxane having at least two silicon-bonded alkenyl-functional groups per molecule. The alkenyl group is preferably linear having up to 6 carbon atoms, as exemplified by hexenyl, vinyl, allyl or pentenyl, or may be cycloalkenyl such as cyclohexenyl.

(A) can be for example a linear organopolysiloxane having the general formula

YX₂SiO(X₂SiO)ₓ(XYSiO)_{y}SiX₂Y

wherein each X denotes independently a phenyl group or an alkyl or cycloalkyl group having from 1 to 10 carbon atoms, for example, methyl, ethyl, propyl, butyl or cyclohexyl; each Y denotes an alkenyl group; and X and Y are such that (A) has a viscosity at 25° C. in the range of from 50 to 5000mm²/s, most preferably 200 to 500 mm²/s. At least 90% of all the X substituents of (A) are preferably methyl groups, most preferably all being methyl groups. It is preferred that no more than 1% of all units of (A) organopolysiloxane are units with an alkenyl group, as otherwise there is the possibility of crosslinking the release coating composition too much upon curing. Preferably y=0. It is possible but not preferred that small amounts (preferably less than 2% of all the substituents present) of other substituents are present, for example hydroxyl groups.

A preferred siloxane (A) is a branched siloxane comprising:

i) one or more Q units of the formula(SiO_{4/2}) and

ii) from 15 to 995 D units of the formula R^{b}₂SiO_{2/2}

which units (i) and (ii) may be inter-linked in any appropriate combination, and

iii) M units of the formula R^{a}R^{b}₂SiO_{1/2}, wherein the R^{a} and R^{b} substituents are selected from alkyl and alkenyl groups having 1 to 6 carbon atoms, at least three R^{a} substituents in the branched siloxane being alkenyl units. The branched siloxane preferably contains at least two polydiorganosiloxane chains of the formula (R^{b}₂SiO_{2/2})n where each n is independently from 2 to 100. Preferably at least 50% of R^{a} substituents are alkenyl groups; most preferably each R^{a} substituent is an alkenyl group. Preferably each R^{b} substituent is an alkyl group, most preferably methyl. The branched siloxane most preferably comprises at least one Q unit bonded to four (R^{b}₂SiO_{2/2})n chains and for example can have the formula

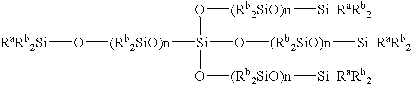

where each n is independently from 1 to 100. The branched siloxane preferably has a viscosity of from 50 mm²/s to 10000 mm²/s at 25° C., more preferably up to 1000 mm²/s. The branched siloxane can be prepared by mixing a compound having the general formula (SiO_{4/2})(R^{a}R^{b}₂SiO_{1/2})₄ with a cyclic polydiorganosiloxane, and/or a substantially linear hydroxy terminated polydiorganosiloxane, causing the mixture to react in the presence of an acid or phosphazene base catalyst at a temperature of up to 180° C. and neutralising the reaction mixture. The branched siloxane and its preparation are described in the copending British Patent Application 9917372.6.

The organohydrogenpolysiloxane crosslinking agent (B) generally contains at least three Si—H groups and may have the general formula:

R^{t}₃SiO_{1/2}((CH₃)₂SiO_{2/2})_{d}(R^{t}₂SiO_{2/2})ₑ)SiO_{1/2}R^{t}₃

where each R^{t} may be an alkyl group having 1 to 4 carbon atoms or hydrogen, d is 0 or an integer, e is an integer such that d+e is from 8 to 100. Alternatively the cross-linking agent may be an MQ resin consisting of units of the general formula SiO_{4/2} and R^{q}₃SiO_{1/2} wherein at least three R^{q} substituents are hydrogen atoms and the remainder are alkyl groups, or may be a rake or comb polymer comprising a polydiorganosiloxane chain containing one or more T or Q units having a subchain of diorganosiloxane units attached thereto. It is preferred that the hydrosiloxane crosslinker has a viscosity of from 5 to 200 mm²/s at 25° C., more preferably 10 to 100 mm²/s, most preferably 10 to 30 mm²/s. The crosslinking agent (B) is preferably present in an amount such that the ratio of the total number of Si—H groups in the release coating composition to aliphatically unsaturated hydrocarbon groups in the composition is from 0.9:1 to 8:1, more preferably 1.1:1 to 2.5:1, most preferably 1.2:1 to 2:1.

Suitable hydrosilylation catalysts include complexes or compounds of group VIII metals, for example, platinum, ruthenium, rhodium, palladium, osmium and indium. Preferred catalysts are platinum compounds or complexes including chloroplatinic acid, platinum acetylacetonate, complexes of platinous halides with unsaturated compounds, for example, ethylene, propylene, organovinylsiloxanes and styrene, hexamethyldiplatinum, PtCl₂.PtCl₃ and Pt(CN)₃. Alternatively the catalyst may be a rhodium complex, for example, RhCl₃(Bu₂S)₃.

The aminoalkyl siloxane or aminoalkyl silane contains at least one aminoalkyl group. It is preferred that that each aminoalkyl group in the aminoalkyl siloxane or aminoalkyl silane is a monoamino-alkyl group. Each amino group in the aminoalkyl group is preferably a primary amine group —NH2. Secondary amine groups can be present but are not preferred. Each aminoalkyl group preferably contains 1 to 18, preferably 2 to 6, carbon atoms. An aminoalkyl silane can for example be an aminoalkyl trialkoxy silane such as a 3-aminopropyl or 2-aminoethyl trialkoxy silane, for example 3-aminopropyl triethoxy silane or 3-aminopropyl trimethoxy silane, or an aminoalkyl alkyl dialkoxy silane such as a 3-aminopropyl methyl or 2-aminoethyl methyl dialkoxy silane, for example 3-aminopropyl methyl dimethoxy silane or 3-aminopropyl methyl diethoxy silane. The aminoalkyl siloxane or silane is preferably substantially non-volatile at 100° C., and most preferably non-volatile at 160° C. For this reason aminoalkyl siloxanes are generally preferred to silanes.

An aminoalkyl siloxane can be a condensation product of such an aminoalkyl trialkoxy silane or aminoalkyl alkyl dialkoxy silane, optionally together with precursors for unsubstituted diorganosilaoxane units. Particularly preferred aminoalkyl siloxanes include substantially linear siloxanes comprising units of the formula -R2SiO— present as at least 50% of the siloxane units in the aminoalkyl siloxane and units of the formula -RR′SiO— or —R′2SiO—, where each R denotes independently a phenyl group or an alkyl or cycloalkyl group having from 1 to 10 carbon atoms and each R′ denotes independently an aminoalkyl group having 1 to 18 carbon atoms. By “substantially linear” we mean siloxanes containing no more than 10%, preferably no more than 5%, branching units such as RSiO3/2 or SiO4/2 units. The groups R in the aminoalkyl siloxane are most preferably methyl groups, although ethyl, propyl, butyl or cyclohexyl groups are alternatives. The aminoalkyl siloxane can for example comprise at least 75% or even over 90% dimethylsiloxane units together with alkyl aminoalkyl siloxane units such as methyl 3-aminopropyl siloxane units. Such a substantially linear aminoalkyl siloxane has the advantage of giving improved anchorage to the substrate without impairing the rheological properties of the release coating composition.

The aminoalkyl siloxane or aminoalkyl silane is preferably present at 0.1 to 20% by weight of the release coating, most preferably at 1 or 2% up to 5%.

The aminoalkyl silane or siloxane may retard the cure of the release coating. This can be counteracted by use of a higher cure temperature. Coated polyester film, for example, can be cured at a temperature in the range 120-180° C., particularly 150-160° C., compared to the temperatures of 80-120° C. typically used to cure release coated paper liners. Amounts of more than 5% and particularly more than 10% of the aminoalkyl silane or siloxane may reduce the level of cure achieved even at the higher temperatures. The presence of both secondary and primary amine groups generally lead to more cure inhibition than silanes or siloxanes containing only primary amine groups.

The presence of the aminoalkyl silane or siloxane generally tends to slightly reduce the release force, which is advantageous rather than otherwise since premium release coatings having a low release force are desired. Higher release forces can be obtained by addition of a release modifier.

The composition may additionally comprise one or more inhibitors adapted to prevent the cure of the coating composition from occurring below a predetermined temperature, although this may not be necessary because of the cure inhibiting effect of the aminoalkyl silane or siloxane. Examples of suitable inhibitors include ethylenically or aromatically unsaturated amides, acetylenic compounds, ethylenically unsaturated isocyanates, olefinic siloxanes, unsaturated hydrocarbon diesters, conjugated ene-ynes, hydroperoxides, nitriles and diaziridines, specific examples include methyl butynol, dimethyl hexynol or ethynyl cyclohexanol, trimethyl(3,5-dimethyl-1-hexyn-3-oxy)silane, a maleate for example, Bis(2-methoxy-1-methylethyl)maleate, a fumarate e.g. diethylfumarate or a fumarate/alcohol mixture wherein the alcohol is, for example, benzyl alcohol or 1-octanol and ethenyl cyclohexyl-1-ol.

Preferably the release coating composition has a viscosity of not less than 50 mm²/s and not more than 10000 mm²/s at 25° C., more preferably the viscosity is from 50 to 1000 mm²/s.

The release coating composition is preferably substantially solventless, but can alternatively be a solution in an organic solvent, for example a solution in a hydrocarbon solvent such as xylene or toluene at a concentration of for example 4 to 50% by weight.

Other constituents which may also be added to release coating compositions of the present invention include, for example, silicone release modifiers, bath life extenders such as an alcohol, fillers, reactive diluents, adhesion promoters, solvents, fragrances, preservatives and fillers, for example, silica, quartz and chalk.

Any appropriate silicone release modifier may be used. Examples include an alkenylated silicone resin, an alkenylated polydiorganosiloxane, one or more primary alkenes containing from 12 to 30 carbon atoms, and/or one or more branched alkenes containing at least 10 carbon atoms.

While release coating compositions of the present invention may be prepared by merely premixing the constituents together, it may be more desirable to prepare such compositions in separate parts or packages to be combined at the time the composition is applied as a coating. The packages can for example be:

a first part comprising the alkenyl siloxane and inhibitor, a second part comprising a release modifier and inhibitor, a third part comprising the catalyst and a fourth part comprising the cross-linking agent; or

a first part comprising the alkenyl siloxane and catalyst, a second part comprising a release modifier and the catalyst and a third part comprising the cross-linking agent and inhibitor.

The aminoalkyl siloxane or aminoalkyl silane can be incorporated in any of these packages or be added to the coating bath as a separate component.

The release coating of the invention can be applied to various substrates. It has particular advantages of improved anchorage when applied to polymer substrates, for example polyester, particularly polyethylene terephthalate, polyethylene, polypropylene, or polystyrene films, including oriented and biaxially oriented films, and to plastic coated paper, for example paper coated with polyethylene. It can also be applied to other substrates such as paper and may show improved anchorage to clay coated paper.

A process according to the invention for release coating of a polymer film with a substantially solventless composition comprising a siloxane (A) having terminal alkenyl groups, a crosslinking agent (B) having organohydrogensiloxane groups and a catalyst for the hydrosilylation reaction between (A) and (B) comprises applying the composition to the film and heating the coated film to cure the release coating, and is characterised in that the release coating composition contains an aminoalkyl siloxane or aminoalkyl silane to improve anchorage of the release coating to the substrate.

The polymer film is preferably exposed to a corona discharge before the release coating is applied. Although the aminoalkyl siloxane or silane gives improved anchorage even without corona treatment, the anchorage is further improved if the film is corona treated before coating. Corona treatment is preferably carried out just before coating; the corona discharge station can be incorporated as a pre-treatment in the film coating apparatus. An alternative film pre-treatment to further improve coating anchorage is flame treatment.

The release coating can for example be applied to the polymer substrate by spraying, doctor blade, dipping, screen printing or by a roll coater, e.g. an offset web coater, kiss coater or etched cylinder coater.

After application the release coating is cured on the polymer film at a temperature of 100- 200° C., preferably 120-180° C.; for example at 160° C. a cure time of 15 or 20 seconds has been found effective in laboratory conditions using a fan assisted oven. Under production coater conditions cure can be affected in a residence time of 1.5 to 3 seconds at an air temperature of 160° C. Heating can be carried out in an oven, e.g. an air circulation oven or tunnel furnace or by passing the coated film around heated cylinders.

The invention is illustrated by the following detailed Examples, in which parts and percentages are by weight and all viscosities were measured at 25° C.

### EXAMPLES 1 TO 3

A material, (Vi(CH₃)₂SiO_{1/2})₄(SiO_{4/2}) (21.6 g), where Vi=vinyl, octamethylcyclotetrasiloxane (592 g) and trifluoromethane sulphonic acid (1.2 g) were reacted for 6 hours at a temperature of from 80 to 90° C., neutralized and stripped to yield a dimethylvinyl-endblocked branched MDQ polydiorganosiloxane of viscosity 270 mm²/s, degree of polymerisation 160 and 0.83% vinyl groups, as described in more detail in British Patent Application 9917372.6.

The resulting “Q polymer” was mixed with an acetylenic alcohol cure inhibitor, Dow Corning 8630 (Trade Mark)(a commercially available substantially linear aminoalkyl-functional siloxane comprising 98% dimethylsiloxane units and 2% methyl 3-aminopropyl siloxane units in which substantially all of the amino functionality is present as mono(primary amine) groups, Dow Corning Corporation, Midland, Mich.), a poly(methyl -hydrogensiloxane) crosslinker and a catalyst reaction product of chloroplatinic acid and divinyltetramethyldisiloxane (0.5% Pt) in the proportions shown in Table 1 below. The molar ratio of Si—H groups to vinyl groups in each of the resulting release coatings composition was about 1.5:1.

Mylar A (Trade Mark of DuPont Co., Delaware) polyester film was subjected to a corona discharge at 0.2 kW at a film speed of 10M/min. The above composition was blade coated at 1.1 g/m2 on the treated film at 20° C. and the coated film was cured at 160° C. for 20 seconds in an air circulation oven.

A portion of the cured coated film was immersed in a solution of methyl isobutyl ketone solvent to extract any siloxane which had not been cross-linked. After an hour the sample was removed from the solvent, dried and reweighed. The % extractables indicated in Table 1 are the % weight losses and is a measure of cure (100% extractables=no cure, 0% extractables=complete cure).

Delamination tests (LSRPD) were carried out using a TESA®7475 tape which uses an acrylic adhesive. In each of these tests delamination was undertaken using a Lloyd® Instruments L500 Tensometer at a delamination speed of 0.3 m/min. The release force in cN/25 mm. was measured after 1, 7, 14 and 28 days storage in contact with the adhesive at 23° C. and 50% humidity.

The anchorage between the release coating and the film base was measured after 28 days. A sample of the film coated with the relevant release coating was cut, and the initial coat weight (g/m²) was determined by x-ray fluorescence. The sample was adhered to a flat plastic disc and fitted in to the base of a 3.2 Kg weight. The sample, with the weight applying downward pressure, is then placed on a felt bed with the premium release coated face of the sample in contact with the felt surface. The weighted sample was subsequently moved along a 30 cm length of the felt bed at a pre-set speed of 3 m/min on two occasions, utilising different sections of the felt bed on each occasion. The anchorage index is the subsequent coat weight divided by the initial coat weight and expressed as a percentage.

The results are set forth in Table 1 below, together with the results for a comparative example CE1 using no aminoalkyl siloxane.

TABLE 1

| Formulation | Ex. 1 | Ex. 2 | Ex. 3 | CE1 |
|---|---|---|---|---|
| Q polymer | 97 | 96 | 95 | 100 |
| Inhibitor | 0.18 | 0.18 | 0.18 | 0.18 |
| Aminosiloxane | 3 | 4 | 5 | 0 |
| Crosslinker | 3.36 | 3.36 | 3.36 | 3.36 |
| Catalyst | 2.4 | 2.4 | 2.4 | 2.4 |
| Properties | | | | |
| % Extractable | 4 | 6 | 2 | 2 |
| Anchorage | 96 | 92 | 95 | 5 |
| Release force | | | | |
| 1 day | 7 | 7 | 9 | 9 |
| 7 days | 8 | 9 | 10 | 13 |
| 14 days | 9 | 9 | 8 | 13 |
| 28 days | 9 | 8 | 9 | 13 |

### EXAMPLE 4

A material, Syl-Off 7680-040, 97 parts (Trade Mark of Dow Corning Corporation, Midland, Mich.), a commercially available linear vinyl end-capped polydimethylsiloxane, was mixed with 0.15% methylbutynol inhibitor, 3 parts Dow Corning 8630 aminoalkyl siloxane, 3.33 parts poly(methylhydrogen)siloxane crosslinker and 2.4 parts of the catalyst used in Example 1. The resulting release coating composition having a Si—H:vinyl molar ratio of 2.6:1 was coated on Mylar A polyester film, cured and tested as described in Example 1. A release coating based on the same materials but containing no aminoalkyl siloxane was similarly tested, and the results are shown in Table 2.

TABLE 2

| Properties | Ex. 4 | CE2 |
|---|---|---|
| % Extractables | 9 | 5 |
| Anchorage | 90 | 4 |
| Release force | | |
| 1 day | 9 | 21 |
| 7 days | 10 | 21 |
| 14 days | 10 | 18 |
| 28 days | 9 | 19 |

### EXAMPLE 5

Following the procedure described in Example 1, a Q-branched polymer of degree of polymerization 180 was prepared. Q-polymer, 2500 gm. was mixed with 125 g Dow Corning 8630 aminoalkyl siloxane, 87.2 g poly(methylhydrogen)siloxane crosslinker, 5.4 g acetylenic alcohol inhibitor and 72 g of the catalyst of Example 1 to form a release coating composition.

Mylar SC polyester film was corona treated at 3 kW with a film speed of 300 m/min. and coated with the above release coating, which was cured at 150° C. The release force was 40 cN/25 mm and the anchorage index was 84% (cf 20 cN/25 mm and 5% for a similar release coating containing no aminoalkyl siloxane).

### EXAMPLES 6 TO 12

Syl-Off 7680-040 (V-polymer) was mixed with Dow Corning 8630 aminoalkyl siloxane, acetylenic alcohol inhibitor, a poly(methylhydrogensiloxane) crosslinker, the catalyst used in Example 1 and an additive which was either a vinyl siloxane release modifier (VSRM) or an alkylolefin-containing release modifier (AORM) in the amounts shown in Table 3 below. The Si—H/vinyl molar ratio was about 2.6:1 in each Example. The % extractables, anchorage and release force were measured as described in Example 1 and are listed in Table 3.

TABLE 3

| Formulation | Ex. 6 | Ex. 7 | Ex. 8 | Ex. 9 | Ex. 10 | Ex. 11 | Ex. 12 |
|---|---|---|---|---|---|---|---|
| V-polymer | 96 | 76 | 56 | 36 | 76 | 56 | 36 |
| Inhibitor | 0.18 | 0.18 | 0.18 | 0.18 | 0.18 | 0.18 | 0.18 |
| VSRM | — | 20 | 40 | 60 | — | — | — |
| AORM | — | — | — | — | 20 | 40 | 60 |
| Aminoalkyl | 4 | 4 | 4 | 4 | 4 | 4 | 4 |
| siloxane | | | | | | | |
| Crosslinker | 3.33 | 5.56 | 7.78 | 10.01 | 5.56 | 7.78 | 10.01 |
| Catalyst | 2.4 | 2.4 | 2.4 | 2.4 | 2.4 | 2.4 | 2.4 |
| Properties | | | | | | | |
| % Extracted | 3 | 3 | 3 | 4 | 4 | 5 | 6 |
| Anchorage | 97 | 94 | 96 | 91 | 52 | 95 | 89 |
| Release force | | | | | | | |
| 1 day | 9 | 9 | 9 | 12 | 11 | 16 | 86 |
| 7 days | 9 | 11 | 12 | 13 | 12 | 19 | 92 |
| 14 days | 10 | 12 | 15 | 15 | 14 | 21 | 100 |
| 28 days | 10 | 12 | 12 | 13 | 18 | 24 | 145 |

What is claimed is:

1. A release coating composition, comprising a siloxane (A) having terminal alkenyl groups, a crosslinking agent (B) having organohydrogensiloxane groups and a catalyst for the hydrosilylation reaction between (A) and (B), characterised in that the release coating composition contains an aminoalkyl silicon compound, selected from the group consisting of:
(i) aminoalkyl siloxanes and,
(ii) aminoalkyl silanes,
in which each amino group is a primary amine group.

2. A composition according to claim 1, wherein the aminoalkyl silicon compound is selected from the group consisting of:
(i) an aminoalkyl trialkoxysilane,
(ii) an aminoalkyl alkyl dialkoxy silane and,
(iii) a condensation product thereof.

3. A release coating composition, comprising a siloxane (A) having terminal alkenyl groups, a crosslinking agent (B) having organohydrogensiloxane groups and a catalyst for the hydrosilylation reaction between (A) and (B), characterised in that the release coating contains an aminoalkyl siloxane, the aminoalkyl siloxane being a substantially linear siloxane comprising units of the formula -R2SiO— present as at least 50% of the siloxane units in the aminoalkyl siloxane and units of the formula -RR′SiO— or -R′2SiO— where each R denotes independently a phenyl group or an alkyl or cycloalkyl group having from 1 to 10 carbon atoms and each R′ denotes independently an aminoalkyl group having 1 to 18 carbon atoms.

4. A composition according to claim 3, wherein each amino group in the aminoalkyl siloxane is a primary amine group.

5. A composition according to claim 1, wherein each aminoalkyl group in the aminoalkyl silicon compound is a monoamino-alkyl group.

6. A composition according to claim 1, wherein the aminoalkyl silicon compound is present at 0.1 to 20% by weight of the release coating.

7. A composition according to claim 1, wherein the release coating composition is substantially a solventless composition.

8. A substantially solventless release coating composition for application to a polymer substrate, comprising a siloxane (A) having terminal alkenyl groups, a crosslinking agent (B) having organohydrogensiloxane groups and a catalyst for the hydrosilylation reaction between (A) and (B), characterised in that the release coating composition contains an aminoalkyl silicon compound selected from the group consisting of
(i) aminoalkyl siloxanes and
(ii) aminoalkyl silanes.

9. A process for preparing a release coating on a polymer film using a substantially solventless composition comprising a siloxane (A) having terminal alkenyl groups, a crosslinking agent (B) having organohydrogensiloxane groups and a catalyst for the hydrosilylation reaction between (A) and (B), comprising applying the composition to the polymer film and heating the coated film to cure the release coating, characterised in that the release coating composition contains an aminoalkyl silicon compound selected from the group consisiting of:
(i) aminoalkyl siloxanes and
(ii) aminoalkyl silanes.

10. A process according to claim 9, wherein the polymer film is subjected to a corona discharge before the release coating is applied.

11. A process according to claim 9, wherein the release coating is cured on the polymer film at a temperature of 100-200° C.
